(19) United States
(12) Patent Application Publication
(10) Pub. No.: US 2009/0107613 A1
(43) Pub. Date: Apr. 30, 2009

(54) Tool and Method for the Application of Wallpaper Border

(76) Inventor: Ron Cosentino, Seneca Falls, NY (US)

Correspondence Address: BROWN & MICHAELS, PC;400 M & T BANK BUILDING, 118 NORTH TIOGA ST, ITHACA, NY, 14850, US

(21) Appl. No.: 11/931,960

(22) Filed: Oct. 31, 2007

(51) Int. Cl. B32B 37/02; E04F 13/00

(52) U.S. Cl. 156/71; 156/577

(57) ABSTRACT

The present invention pertains to a tool for the application of wallpaper border that simplifies the process of applying wallpaper border. The border application tool is especially useful in situations where the border is applied to a wall at its juncture with a ceiling. The border application tool includes a base plate, a spool for holding a roll of wallpaper border, an applicator cylinder for pressing border fed from the spool onto a wall, a paper guide for retaining the border on the application cylinder as it is fed from the spool, and an auxiliary roller that aids in applying the border, especially at corners of rooms. The spool that holds the paper has an adjustable platform that allows wallpaper border of different heights to be supported and applied. In addition, the border application tool includes following elements that provide smooth motion against a surface perpendicular to the wall. The base plate has a handle attached to its other surface. The handle is preferably of sufficient length (or can accept extensions) to permit a user to apply border at ceiling height without use of a ladder.

### BACKGROUND OF THE INVENTION

1. Field of the Invention

The invention pertains to the field of wallpaper application tools. More particularly, the invention pertains to an apparatus and method for the application of wallpaper border to a wall adjacent to a perpendicular surface such as a ceiling.

2. Description of Related Art

The present invention pertains particularly to the application of wallpaper border. Wallpaper border is distinguished from wallpaper by its size and by the manner in which it is applied. While wallpaper is typically about 24 to 27 inches wide and is applied by placing a number of vertically adjacent strips to cover a surface, border is narrower (typically less than 12 inches) and is normally applied horizontally as a single strip to provide a decorative accent to a surface. Most frequently, wallpaper border is applied at the top of a wall along its juncture with the ceiling.

When one applies wallpaper border to a wall, the best appearance is achieved if the border is applied evenly. This is especially important when the border is applied where a wall intersects an adjacent surface such as a ceiling—here any unevenness in the application of the border results in a conspicuous and unsightly misalignment with the adjacent surface. The appearance is also superior if the border is applied in long continuous strips so that the number of seams between discrete pieces is minimized.

The process of applying border normally begins by applying adhesive (paste) to the back surface of the entire length of a strip of border to be hung and then consolidating the length of border into a loose roll for easier handling. The border is then applied to the wall paste side in. Typically, this is done manually by holding the roll of border in one hand while drawing border from the roll and placing it in its desired position on the wall using the other hand. This may be followed by the use of a roller or wiper to smooth the border and ensure good contact between the adhesive and the wall.

It requires considerable skill to quickly and evenly affix the border to the wall in the brief period during which the adhesive remains moist. The process can be particularly challenging if the border is applied in long lengths or at a height that requires the use of a ladder (such as at the juncture with the ceiling). A worker applying the border with a ladder can reach only a limited section of a wall from a given ladder position. Thus, after applying border to that section of wall, the worker must reposition the ladder before applying additional border. This process may need to be repeated numerous times to apply a single long piece of border. It will be apparent that this can be a difficult process for a lone worker who must hold the pasted roll of border without allowing the portion already affixed to the wall to move, while repositioning the ladder. This situation can be simplified by using scaffolding, but scaffolding is expensive, time consuming to erect, and is typically not available for do-it-yourself projects. The process can also be simplified by applying the border in shorter sections but, as noted above, that compromises the appearance of the finished border installation.

Because of these challenges, a number of tools intended to simplify the installation of wallpaper border have been developed. One such tool is disclosed in U.S. Pat. No. 5,478,432 to Vester. Vester's apparatus is designed to be attached to a wall at the height at which the border will be applied. The apparatus supports a rolled length of pasted wallpaper such that it can be paid out and applied to the wall without the need for the installer to hold the roll in one hand. Similar tools are shown in U.S. Pat. Nos. 5,328,543 and 6,173,749. These latter devices, rather than fastening to the wall, consist of poles which rest on the floor and support a roll of border at the desired installation height. These devices still require a worker to repeatedly move and ascend a ladder to complete the installation at ceiling height.

A different class of tools in the prior art hold a roll of pasted border on a spool and include a handle that a user can hold in one hand. An end of the border is placed on the wall and the tool is drawn along the wall. Rotation of the roll around the spool allows the border to be dispensed as the tool is moved along the wall. Tools of this type are shown in U.S. Pat. Nos. 5,280,869, 5,453,152, and 7,059,375. A similar device is disclosed in U.S. Pat. No. 5,403,430 to Araujo et al. In addition to the spool and handle of the devices above, Araujo's device includes a roller to press the border against the wall, and a wiper blade to remove excess paste from the face of the border as it is applied.

None of the tools described above provide a way to conveniently apply wallpaper border at a defined distance from an adjacent surface or provide an auxiliary roller to aid in the application of border in corners. There remains a need for a device that allows for a single unskilled worker to easily apply wallpaper border in long sections such that the border is applied quickly and evenly relative to an adjacent surface.

### SUMMARY OF THE INVENTION

The present invention pertains to a tool for the application of wallpaper border that simplifies the process of applying wallpaper border. The tool is especially useful in situations where the border is applied to a wall at its juncture with a ceiling.

The tool includes of a base plate with a surface on which a spool for holding a roll of wallpaper border, an applicator cylinder for pressing border fed from the spool onto a wall, a paper guide for retaining the border on the application cylinder, and an auxiliary roller that aids in applying the border, especially at corners of rooms, are all mounted. The spool that holds the paper has an adjustable platform that allows wallpaper border of different heights to be supported and applied. In addition, the tool includes following elements that provide smooth motion against a surface perpendicular to the wall. These allow the apparatus to accurately follow a surface adjacent to the wall to which the border is being applied, and result in even alignment of the border with the adjacent surface. This greatly simplifies the task of evenly aligning the border during application. The base plate has a handle attached to its other surface. The handle can be of sufficient length (or can accept extensions) to permit a user to apply border at ceiling height without use of a ladder.

### BRIEF DESCRIPTION OF THE DRAWINGS

FIG. 1A shows a perspective view of a border application tool in an embodiment of the present invention.

FIG. 1B shows a side view of the embodiment of FIG. 1A.

FIG. 2A shows a perspective view of the top of a border application tool in an embodiment of the present invention.

FIG. 2B shows a perspective view of the bottom of a border application tool in an embodiment of the present invention.

FIG. 3A shows a top view of the border application tool being used to apply border to a flat wall.

FIG. 3B shows a top view of the border application tool being used to apply border an inside corner where two walls intersect.

FIG. 3C shows a top view of the border application tool being used to apply border to an outside corner where two walls intersect.

### DETAILED DESCRIPTION OF THE INVENTION

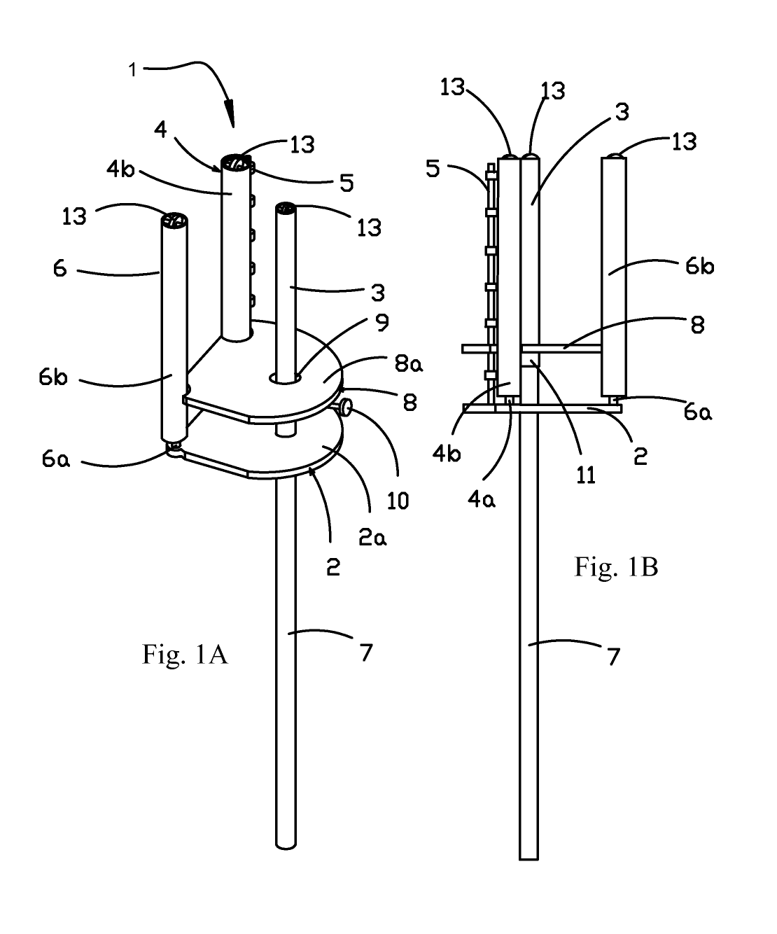

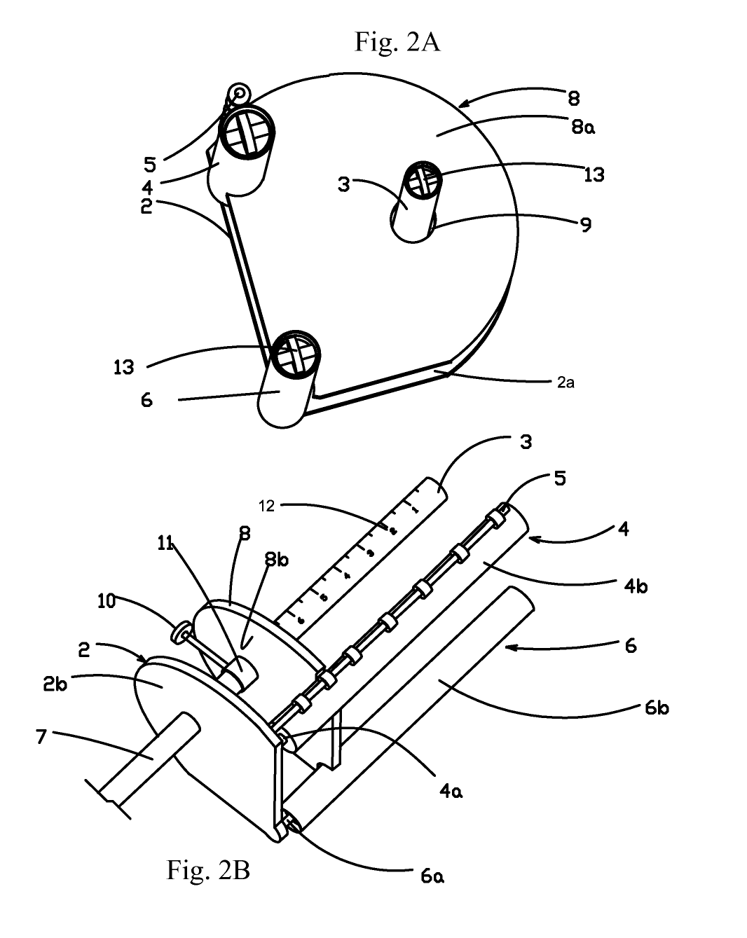

FIGS. 1A-2B show one embodiment of a border application tool 1 of the invention. The border application tool 1 includes a base plate 2 which has a first surface 2a and a second surface 2b. From first surface 2a, several components extend upward. These components include the paper retaining spool 3, the applicator cylinder 4, the paper guide 5, and the auxiliary roller 6. A handle 7 is attached to the second surface 2b.

The paper retaining spool 3 is present to retain a roll of pasted wallpaper border and to allow the roll to rotate as material is drawn from it. The spool 3 is non-rotatably attached to the base plate 2. The attachment of spool 3 to base 2 may be achieved by any suitable means including, but not limited to: being retained by fasteners; having a threaded portion adapted to mate with a complementary threaded element integral to or attached to the base plate; gluing; welding; or by molding, casting, or forging the spool and base plate as a single piece. In the embodiment illustrated in FIGS. 1A-2B, the paper retaining spool 3 passes through a hole in the base plate and is bonded to the base plate. Paper retaining spool 3 is preferably round and preferably has a diameter similar to or smaller than the diameter of the hole in the center of a roll of commercial wallpaper border. The length of paper retaining spool 3 is not critical to the operation of the border application tool, but is preferably chosen to accommodate at least the height of the larger types of commercially available wallpaper borders. A length of between about eight inches and about twelve inches is typically sufficient, but shorter or longer border application tools adapted to special applications are also encompassed by the invention.

The paper retaining spool 3, supports upon its length an adjustable paper holding platform 8. The platform 8 supports the roll of wallpaper border, while keeping the edges of the roll in the same plane (i.e. square) and to allow the user to adjust the height upon the spool 3 at which the roll of border is supported. Platform 8 has a planar upper surface 8a that is substantially perpendicular to the longitudinal axis of spool 3. The platform 8 has a through hole 9 to accommodate the shaft of the paper retaining spool 3, and includes a means to adjustably secure platform 8 at various positions along the shaft of spool 3. In the embodiment shown in FIGS. 1A and 2B, the securing means includes a thumbscrew 10 engaged in a threaded through hole in collar 11, the collar being fixedly attached, or integral to the lower surface of platform 8. Thumbscrew 10 may be tightened against the spool to secure the platform 8 at a desired height. In a preferred embodiment, the shaft of the paper retaining spool 3 has a calibrated length scale 12 imprinted upon it as shown in FIG. 2B. This allows a user to align the planar upper surface 8a of the platform 8 at a known distance from the top of the spool 3 by reference to the length scale 12. This feature simplifies adjustment of the border application tool 1 for use with different widths of wallpaper border. Alternate means of adjustment of platform 8 are possible and include, but are not limited to: a clamp, a cam, or a retractable pin that engages holes in the shaft of the spool.

The shape of the adjustable platform 8 is not critical to the operation of the border application tool, however the platform preferably has a planar surface sufficiently large to effectively support an entire roll of pasted, loosely rolled, commercially available border. In this way the roll of border is supported with its edges evenly aligned in a plane defined by the surface of the platform. The border is thereby kept square and will remain straight as it is applied to the wall. In the embodiment shown in FIGS. 1A-2B, the platform 8 has a size and shape similar to the base plate 2, and it is contoured to accommodate the applicator cylinder 4, paper guide 5, and auxiliary roller 6 without interfering with their operation.

The applicator cylinder 4 extends from surface 2a of the base plate, and its longitudinal axis is substantially parallel to the longitudinal axis of spool 3. The applicator cylinder 4 applies the wallpaper border along a wall's surface. It performs this function by rotating and rolling the paper between the surface of the cylinder and the surface of the wall, thereby pressing the adhesive surface of the wallpaper border to the wall as the cylinder is rolled along the wall. The applicator cylinder 4 includes a fixed shaft 4a attached to the base plate 2, and a cylinder 4b rotatably mounted upon the shaft. Both the shaft 4a and the cylinder 4b are parallel to the shaft of spool 3.

The cylinder 4b may be mounted upon the shaft 4a by any suitable rotatable mounting known in the art including, but not limited to, simple passage of the shaft 4a though a sized hole in the cylinder, or mounting upon one or more bearings of any design as is well known in the art. As best shown in FIG. 2A, the shaft 4a is preferably located near enough to an edge of base plate 2 so that the outer surface of the cylinder 4b overhangs at least one edge of the base plate 2. The cylinder 4b is thereby capable of being placed tangentially against a wall parallel to the cylinder without interference by the base plate 2. More preferably, as shown in FIG. 2A, the shaft 4a is located near enough to a corner of the base plate 2 that the outer surface of cylinder 4b overhangs the base plate 2 on two sides and is thereby capable of being placed tangentially against two walls where they intersect at an inside corner without interference of base plate 2 on either wall. Preferably, the outer surface of cylinder 4b is made of a resilient material such as rubber, the resiliency of the cylinder surface helps to press the border against any minor irregularities that may be present on the surface of a wall.

The paper guide 5 is adjacent to the applicator cylinder 4. The paper guide 5 guides border being drawn from the spool onto the applicator cylinder 4. Paper guide 5 helps to retain the border in the proper position for the applicator cylinder to act upon it. Paper guide 5 may be either rotatable or fixed. As shown in FIGS. 1A, 1B, 2A and 2B, it is located near to the applicator cylinder 4 so that the longitudinal axes of the paper guide 5 and applicator cylinder 4 are parallel. A small space is present for the paper to pass between paper guide 5 and the applicator cylinder 4. In the embodiment shown in FIG. 1B, paper guide 5 includes of a fixed shaft 5a with several rotatable elements 5b mounted upon it. In alternate embodiments, the paper guide may include just a fixed shaft, a rotatable shaft, a fixed shaft with a single rotatable element, or a fixed shaft with a spring biased longitudinal element that maintains some tension upon the border. Preferably, the paper guide 5 is no longer than the applicator cylinder 4 and more preferably, it has a length similar to, or the same as, the applicator cylinder 4.

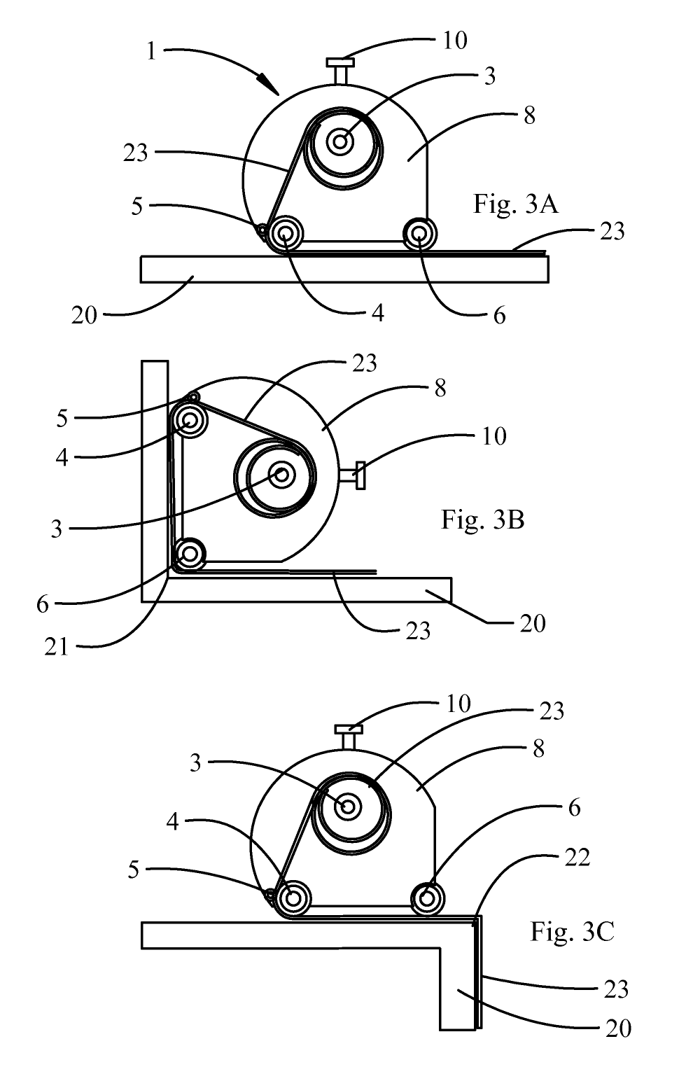

The auxiliary roller 6 is similar in design to the application cylinder. The purpose of the auxiliary roller 6 is two-fold. First, as shown in FIG. 3A, while applying border 23 to a flat wall 20, the border application tool 1 may be held so that the auxiliary roller 6 presses against the border 23 that has just been applied to the wall by the application cylinder 4. Second, as shown in FIG. 3B, when applying border and reaching an inside corner 21 between two walls 20 and 24, a user can rotate the handle of the border application tool 1 so that the application cylinder 4 follows the second wall 24 while keeping the auxiliary roller 6 in contact with the first wall 20, further rotation then causes the auxiliary roller 6 to press the border 23 into the corner. If the auxiliary roller 6 has a smaller diameter than the application cylinder 4, this will result in better application of border 23 at the corner 21 because the auxiliary roller will be better able to access the corner 21. Auxiliary roller 6 includes a roller 6a rotatably mounted on a fixed shaft 6b. Both the shaft 6a and the roller 6b are substantially parallel to the applicator cylinder 4. The construction and mounting requirements for the auxiliary roller 6 are similar to those described above for the applicator cylinder 4, except that the auxiliary roller 6 preferably has a smaller diameter than the application cylinder 4 and the roller 6b need not necessarily be cylindrical-certain polygonal cross sections may also be useful: for instance, triangular profiles, or rounded triangular profiles may enhance installation at inside corners.

The border application tool 1 preferably also includes surface following elements 13 that allow the tool to accurately follow a surface adjacent to a wall. Surface following elements 13 allow a user to accurately apply wallpaper border next to—or a predetermined distance from—an adjacent surface such as a ceiling. Preferably, there are at least three such surface following elements 13 which define a plane. The plane defined by the surface following elements 13 is preferably parallel to the planar upper surface 8a of the adjustable platform 8. The surface following elements 13 may be positioned and retained by any suitable manner including, but not limited to: attachment to one or more shafts or frames specifically provided for that purpose, such shafts or frames may be attached to other elements of the border application tool 1 such as the base plate 2 or adjustable platform 8; attachment to the upper ends of one or more of the paper retaining spool 3, the applicator cylinder 4b, or its shaft 4a, the auxiliary roller 6b, or its shaft 6a, and the paper guide S; or by a combination of any of the above. In the embodiments shown in FIGS. 1A-3C, the surface following elements are located at the upper ends of each of the paper retaining spool 3, the shaft of the application roller 4a, and the shaft of the auxiliary roller 6a.

The surface following elements 13 should provide low friction movement of the border application tool 1 against a surface they are in contact with such as a ceiling. Suitable surface following elements include, but are not limited to: ball bearings; roller bearings; rotatable wheels (optionally pivotable); beads; low friction plastics or coatings; or other such elements well known in the art. Suitable low friction plastics or coatings include, but are not limited to: materials such as fluoropolymer compositions; polyethylene plastics; urethane plastics; and coatings thereof on other materials.

The lower surface 2b of the base plate 2 is coupled to a handle 7. The invention places no particular restrictions on the configuration of the handle 7, its purpose being simply to allow a user to comfortably hold and manipulate the border application tool. In the embodiment depicted in FIG. 1, handle 7 is provided by extending the shaft of the spool 3 through the base plate 2 for a distance beyond surface 2b. In alternate embodiments, the handle may be a separate element from the spool. The handle may be of any form suitable including, but not limited to: a grip, a pole, or simply a threaded socket for receiving commercially available handles or paint roller extensions. The handle 7 may be oriented vertically (i.e. parallel to the longitudinal axis of spool 3) or it can be offset at an angle. Handle 7 may alternatively include one or more pivotable joints that allow the handle, or a portion thereof, to be tilted or rotated. Handle 7 may alternately include a spring or similar biasing means designed to provide a more constant contact force when the border application tool 1 is pressed against a surface (such as a ceiling) adjacent to the wall to which the border is being applied. By providing a handle 7 of sufficient length, either directly or by provision for attachment of extensions, the user of the border application tool 1 can avoid having to use a ladder, thereby greatly simplifying the installation process.

To apply wallpaper border to the upper edge of a wall at its juncture with the ceiling using a border application tool 1 of the present invention, the user would proceed as follows. First, the border application tool 1 is adapted to the height of the selected wallpaper border by fixing the adjustable platform 8 at a suitable height on the spool 3. Normally, this height is selected so that the top edge of the border is even with or slightly below the plane defined by the surface following elements 13. This adjustment process may be aided by the optional length scale 12 imprinted upon the shaft of spool 3. Preferably, scale 12 directly indicates the distance between the planar surface of the adjustable platform 8 and the plane defined by the surface following elements 13. Therefore, for an application where the border will be even with the ceiling following elements 13, the user simply adjusts the platform surface 8a to a height on spool 3 corresponding to the height of the wallpaper border being applied. At this time, if the handle 7 permits adjustments, it is desirable to attach or adjust the handle so that the border application tool 1 may be comfortably wielded at a height and angle suited for the particular installation.

Next, a roll of wallpaper border 23 is selected and adhesive is applied to its backside. In most cases, this step includes wetting a moisture-activated paste already present on the border. The adhesive-bearing border 23 is loosely rolled up and placed upon paper retaining spool 3 of the border application tool 1, so that the lower edge of the roll is square and is in complete contact with the planar upper surface 8a of platform 8. The outer end of the roll is then withdrawn from the roll and directed through the space between the paper guide 5 and the application cylinder 4. The end of the roll is placed on the application cylinder 4 with its adhesive-bearing side facing outward.

The border application tool 1 is next brought to the point on the wall 20 where the user wishes to begin. The border application tool 1 is manipulated so that the application cylinder 4 presses the end of the border 23 onto the wall at the desired point. Simultaneously, the surface following elements 13 are brought into contact with the ceiling. The border application tool 1 is then moved along the wall maintaining pressure between the application cylinder 4 and the wall sufficient to cause the cylinder 4b to rotate upon its shaft 4a. This movement of the border application tool 1 and the rotation of the application cylinder 4 will withdraw border 23 from the roll and press the it against the wall 20. If the user also keeps the surface following elements 13 in contact with the ceiling, the border will be applied in a strip even with the juncture of the wall and ceiling. As shown in FIG. 3A, the border application tool 1 is preferably held so that the auxiliary roller 6 contacts and presses on the paper already applied to the wall, thereby further smoothing and bonding the border.

When the user reaches an inside corner between two walls, such as the 90 degree corner 21 depicted in FIG. 3B, the border application tool 1 is moved along the first wall 20 until the application cylinder contacts the second wall 24. The user then begins to rotate the border application tool 1 so that the applicator cylinder 4 follows the surface of the second wall 24, while the auxiliary roller 6 continues to travel along the first wall 20. When the user has rotated the border application tool 1 90 degrees, the auxiliary roller 6 presses the border 23 into the corner 21, and the user can continue the application by moving the border application tool 1 along the second wall 24. Outside corners 22 are handled similarly as shown in FIG. 3C. These steps are repeated until the desired quantity of border has been applied.

In addition to the application described above, the border application tool 1 may also be useful for application of wallpaper border in other orientations, such as along the edges of walls at inside corners, adjacent to floors, or at intersections with other architectural elements. The border application tool 1 may also be used without engaging the surface following elements 13 to apply border in locations where an adjacent perpendicular surface is not present. Alternatively, to take full advantage of the surface following elements 13, a temporary perpendicular surface (such as a board or shelf) may be held against, or attached to, a wall and removed after the border installation is completed.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An apparatus for applying wallpaper border to a wall comprising:
a) a base plate having a top surface and a bottom surface;
b) an applicator cylinder rotatably mounted upon a first shaft, the first shaft having a longitudinal axis extending from the top surface of the base plate to a free end of the first shaft;
c) a paper guide extending from the top surface of the base plate adjacent and substantially parallel to the applicator cylinder, the paper guide being no longer than the applicator cylinder;
d) an auxiliary roller rotatably mounted upon a second shaft, the second shaft having a longitudinal axis substantially parallel to the first shaft and extending from the top surface of the base plate to a free end of the second shaft;
e) a paper retaining spool having a longitudinal axis substantially parallel to the first shaft and extending from the top surface of the base plate to a free end of the paper retaining spool;
f) a platform adjustably retained on the paper retaining spool such that the platform can be moved along the length of the paper retaining spool and fixed at a plurality of positions thereon, the platform having a planar upper surface, the planar upper surface being substantially perpendicular to the longitudinal axis of the first shaft; and
g) a handle on the bottom surface of the base plate;
wherein an outer surface of the applicator cylinder and an outer surface of the auxiliary roller overhang at least one edge of both the base plate and the platform.

2. The apparatus of claim 1 further comprising a plurality of surface following elements, each surface following element having a surface contacting point;
wherein together, the surface contacting points of the plurality of surface following elements define a plane that is parallel to and above the planar upper surface of the platform.

3. The apparatus of claim 2, wherein the plurality of surface following elements are supported by attachment to an element selected from the group consisting of:
i) a third shaft;
ii) at least one frame specifically provided for that purpose;
iii) the free end of the first shaft;
iv) the free end of the second shaft;
v) a free end of the paper retaining spool;
vi) the paper guide, and
vii) any combination of (i) through (vi).

4. The apparatus of claim 2 wherein each surface following element is attached to one of:
i) the free end of the first shaft;
ii) the free end of the second shaft; and
iii) the free end of the paper retaining spool.

5. The apparatus of claim 4 wherein one surface following element is attached to each of:
i) the free end of the first shaft;
ii) the free end of the second shaft; and
iii) the free end of the paper retaining spool;
wherein a plane defined by a surface contacting point of each of the surface following elements attached to (i)-(iii) is substantially parallel to the planar upper surface of the platform.

6. The apparatus of claim 2, wherein each of the plurality of surface following elements is independently selected from the group consisting of:
i) a ball bearing;
ii) a rotatable wheel; and
iii) a low friction surface.

7. The apparatus of claim 1, wherein the handle comprises a threaded socket for receiving a threaded extension.

8. The apparatus of claim 1, wherein the handle comprises at least one pivotable joint.

9. The apparatus of claim 1, wherein the handle comprises a spring, and wherein the spring exerts a biasing force when the apparatus is pressed against a surface.

10. The apparatus of claim 1, further comprising indicia on at least one of the application roller, the auxiliary roller, and the paper retaining spool, the indicia showing a distance between the planar surface of the platform and a top of the apparatus.

11. The apparatus of claim 1, wherein the auxiliary roller has a circular cross section.

12. The apparatus of claim 1, wherein a diameter of the application cylinder is greater than a diameter of the auxiliary roller.

13. The apparatus of claim 1, wherein the auxiliary roller has a polygonal cross section.

14. The apparatus of claim 1, further comprising a plurality of rollers on the paper guide.

15. A method of applying wallpaper border using an apparatus having a base plate having a top surface and a bottom surface; an applicator cylinder rotatably mounted upon a first shaft, the first shaft having a longitudinal axis extending from the top surface of the base plate to a free end of the first shaft; a paper guide extending from the top surface of the base plate adjacent and substantially parallel to the applicator cylinder, the paper guide being no longer than the applicator cylinder; an auxiliary roller rotatably mounted upon a second shaft, the second shaft having a longitudinal axis substantially parallel to the first shaft and extending from the top surface of the base plate to a free end of the second shaft; a paper retaining spool having a longitudinal axis substantially parallel to the first shaft and extending from the top surface of the base plate to a free end of the paper retaining spool; a platform adjustably retained on the paper retaining spool such that the platform can be moved along the length of the paper retaining spool and fixed at a plurality of positions thereon, the platform having a planar upper surface, the planar upper surface being substantially perpendicular to the longitudinal axis of the first shaft; a handle on the bottom surface of the base plate; and a plurality of surface following elements, each surface following element having a surface contacting point; wherein an outer surface of the applicator cylinder and an outer surface of the auxiliary roller overhang at least one edge of both the base plate and the platform; and wherein the surface contacting points of the plurality of surface following elements define a plane that is parallel to and above the planar upper surface of the platform, comprising the steps of:
a) placing a roll of wallpaper border having adhesive on one surface on the paper retaining spool, such that an edge of the roll is square and rests evenly upon the planar upper surface of the platform and the axis of the roll is substantially perpendicular to the planar upper surface of the platform;
b) drawing an outer end of the roll of wallpaper border through a space between the paper guide and the applicator cylinder such that the end of the roll rests on the applicator cylinder with the adhesive-bearing surface of the roll facing outward;
c) manipulating the handle of the apparatus such that the adhesive-bearing surface at the outer end of the roll of wallpaper border is pressed against a wall by the applicator cylinder and the three surface following elements contact a surface perpendicular to the wall; and
d) drawing the apparatus along the wall a keeping the surface contacting elements in contact with the surface perpendicular to the wall and maintaining sufficient pressure between the applicator cylinder and the wall to cause the application cylinder to rotate upon the first shaft, thereby causing the wallpaper border to be drawn from the roll and be pressed against the wall, the wallpaper border being thereby applied to the wall at a substantially constant distance from the surface perpendicular to the wall.

16. The method of claim 15, further comprising the steps of:
e) prior to reaching an inside corner between a first wall and a second wall, rotating the handle of the apparatus such that the auxiliary roller contacts the border already applied to the first wall by the applicator cylinder;
f) upon reaching the corner, rotating the handle of the apparatus such that the applicator cylinder follows the surface of the second wall, and the auxiliary roller follows the surface of the first wall until it presses the paper into the corner; and
g) continuing to draw the apparatus along the second wall as described in step (d).
